(19) United States
(12) Patent Application Publication
(10) Pub. No.: US 2010/0219690 A1
(43) Pub. Date: Sep. 2, 2010

(54) METHOD AND DEVICE FOR CONTROLLING THE OPERATION OF POWER AT THE POINT OF MAXIMUM POWER

(75) Inventors: Nicola Femia, Baronissi (SA) (IT); Filippo De Rosa, Salerno (IT); Antonio Sirianni, Lamezia Terme (IT); Giovanni Petrone, Castel San Giorgio (IT); Luigi Egiziano, Napoli (IT); Giovanni Spagnuolo, Salerno (IT); Massimo Vitelli, Caserta (IT)

Correspondence Address: YOUNG & THOMPSON, 209 Madison Street, Suite 500, Alexandria, VA, 22314, US

(73) Assignee: UNIVERSITA'DEGLI STUDI DI SALERNO, Fisciano (SA) (IT)

(21) Appl. No.: 12/303,757

(22) PCT Filed: Jun. 7, 2007
(86) PCT No.: PCT/IT07/00406

§ 371 Date: Feb. 19, 2009

(30) Foreign Application Priority Data
Jun. 7, 2006 (IT) SA2006A000016

(51) Int. Cl. H02J 4/00; G05F 1/70

(52) U.S. Cl. 307/77; 323/205

(57) ABSTRACT

A control method and a control device for controlling a supply unit, which enable supply of the maximum power that can be delivered by a power source, the method includes the presence of an absolute maximum on the curve of the power as a function of the voltage at the connection terminals; the supply system set between the power source and the load is preferably a DC/DC switching converter. The control circuit identifies the optimal operating point, using the relation existing between the harmonic components of the power and the harmonic components of the voltage at the terminals of the source. Starting from any value of the voltage at the connection terminals, the control circuit increments the value of the voltage if, for a given value of the frequency, the power and the voltage at the connection terminals are in phase, whilst it decrements the value of the voltage if the power and the voltage are in phase opposition.

### TECHNICAL FIELD OF THE INVENTION

The present invention relates to systems for supply from autonomous electric-power sources, and more precisely to operation and control of supply systems, in which the power source is characterized by the presence of an absolute maximum on the curve of the power as a function of the voltage at its own terminals.

For the aforesaid kind of sources, the power that can be delivered is maximum at a given optimal voltage value. For optimal operation of the supply system, corresponding to supply of the maximum power that can be delivered, it is necessary for the voltage at the terminals of the source to be as close as possible to the optimal voltage value referred to. For this purpose, generally set between the source and the load is an appropriately controlled DC/DC converter. The control circuits and algorithms that are able to guarantee, instantaneously and continuously, an accurate tracking of the optimal operating point are defined by the term “Maximum Power Point Tracking” (MPPT).

A better understanding of the invention will emerge from the following description, where, after a brief examination of the known art, a preferred embodiment of the invention will be described purely by way of non-limiting example with reference to the attached plates of drawings.

In the plates of drawings:

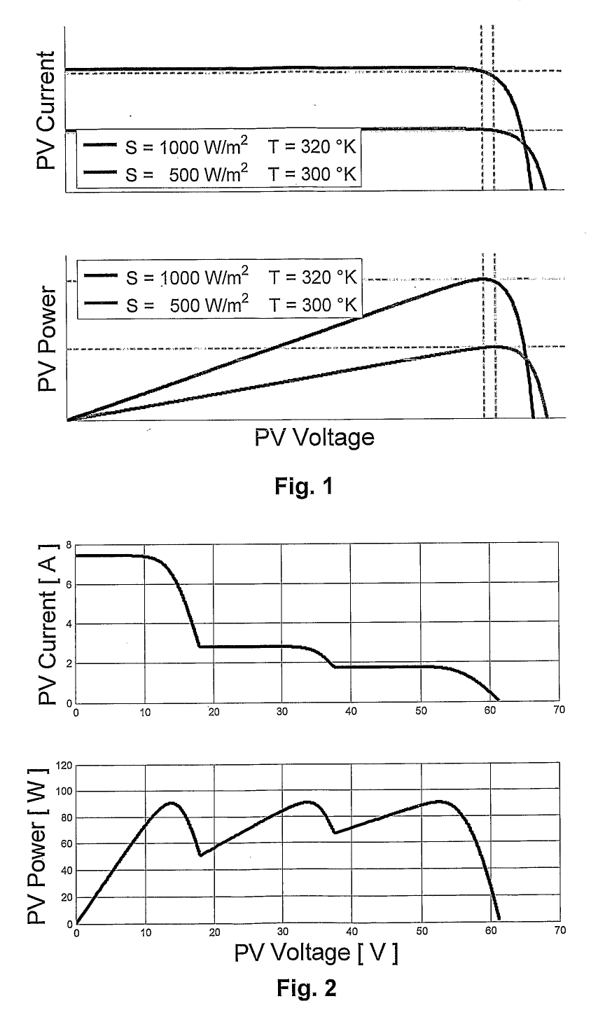

FIG. 1 presents typical I-V and P-V characteristics of a homogeneous photovoltaic field;

FIG. 2 presents I-V and P-V characteristics of a non-homogeneous photovoltaic field: connection of three modules in series;

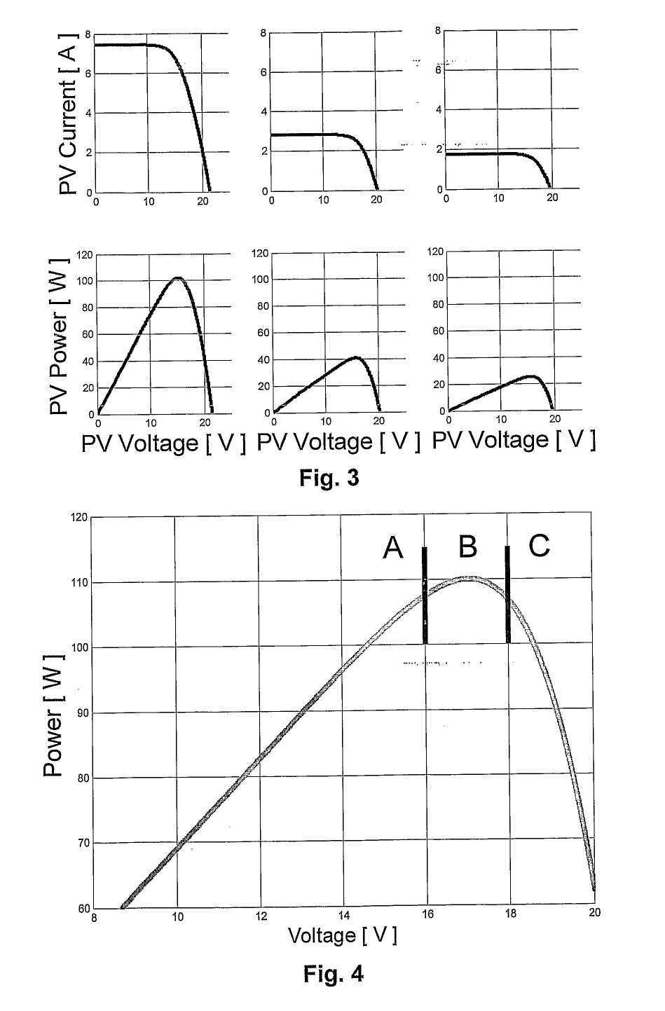

FIG. 3 presents I-V and P-V characteristics of non-homogeneous photovoltaic modules, not connected;

FIG. 4 presents a typical P-V characteristic of a photovoltaic field;

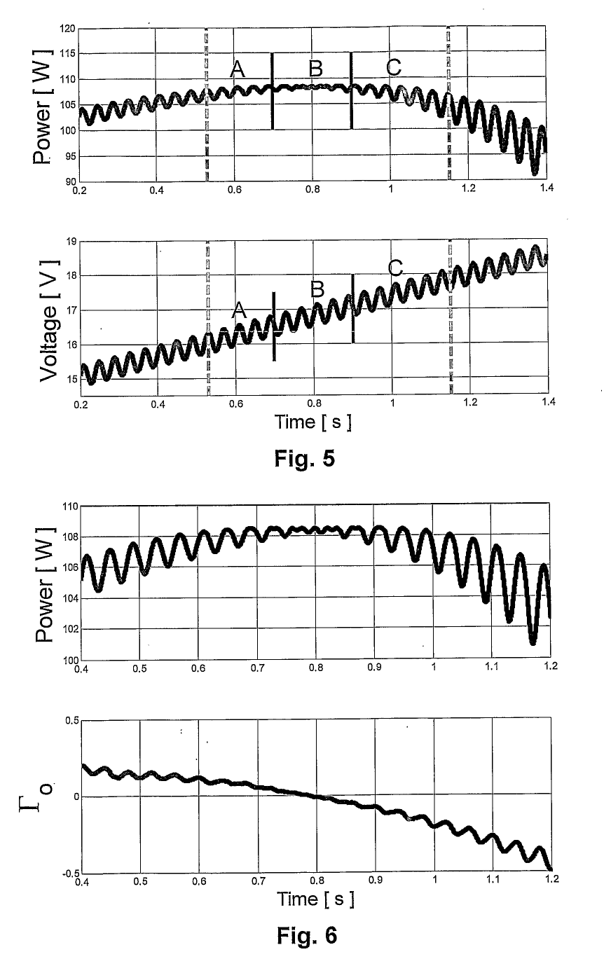

FIG. 5 presents the waveform of the oscillating voltage of a photovoltaic field and the corresponding waveform of the power;

FIG. 6 presents the waveform of the power generated by a photovoltaic field and the corresponding waveform of the quantity Γ(t);

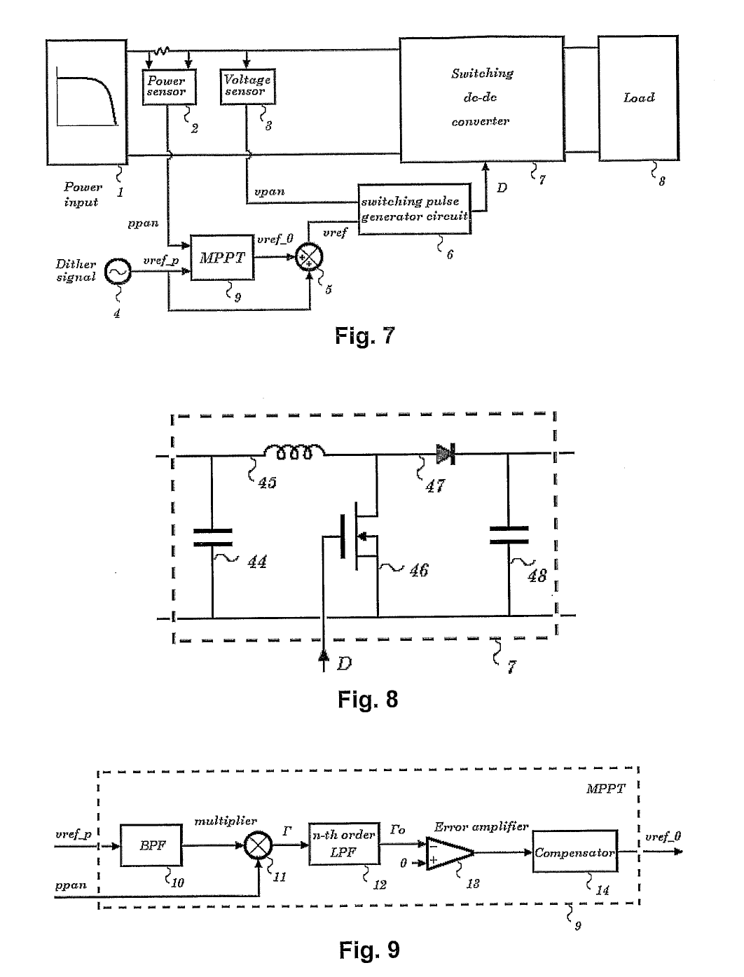

FIG. 7 presents a working block diagram of the invention;

FIG. 8 presents a circuit diagram of a DC/DC boost converter;

FIG. 9 presents a block diagram of the controller;

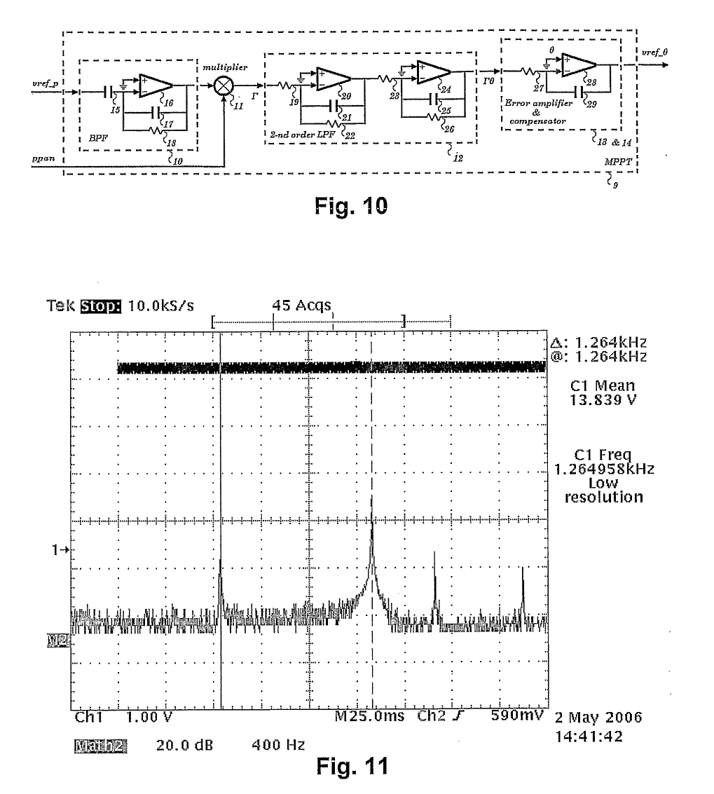

FIG. 10 presents a circuit diagram of the controller;

FIG. 11 presents spectral characteristics of the waveform of Γ, where Ch1 is the voltage at the terminals of the photovoltaic field, and Math3 is the spectrum of the signal Γ;

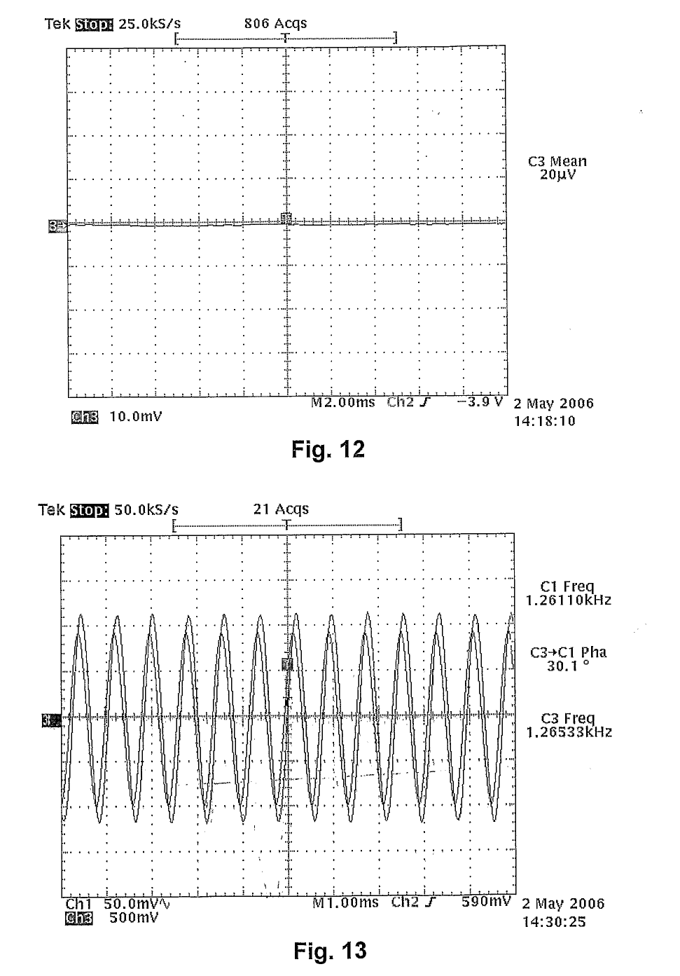

FIG. 12 presents the waveform of the signal Γ₀;

FIG. 13 presents a comparison between the a.c. component of the perturbing signal Ch1 and the a.c. voltage component at the terminals of the photovoltaic field Ch3;

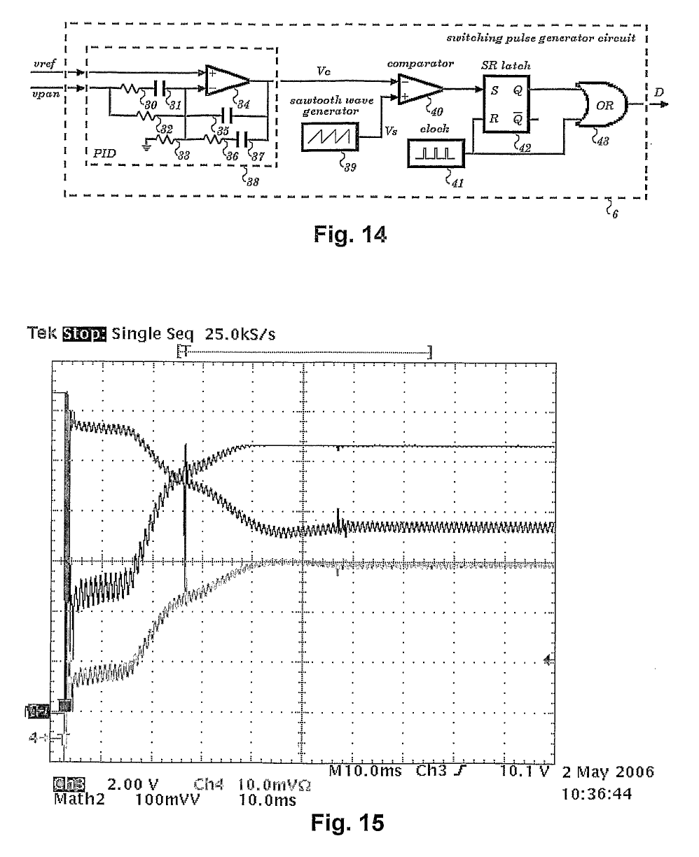

FIG. 14 presents a diagram of the circuit that generates the PWM signal; and

FIG. 15 illustrates start-up of the system, where Ch3 is the voltage at the terminals of the photovoltaic field, Ch4 is the current supplied by the photovoltaic field, and Math2 is the power delivered by the photovoltaic field.

### STATE OF THE ART OF THE TECHNOLOGY

The photovoltaic modules are examples of sources that fall within the category referred to above. We shall define as “photovoltaic field” a single photovoltaic module (or panel) or a set of two or more photovoltaic modules (or panels), connected in series and/or in parallel. FIG. 1 shows the current-voltage and power-voltage characteristics of a homogeneous photovoltaic field for different values of solar irradiation [S] and temperature [T]. The characteristics of FIG. 1 represent just one particular example of a power source in which there is present an absolute maximum on the curve of the power as a function of the voltage, at the connection terminals of the converter to the source.

In particular, in the case of a photovoltaic source, the value of voltage present at the connection terminals of the converter to the source corresponding to which it is possible to deliver the maximum power varies with the climatic conditions, or with the intensity of the solar irradiation and with the temperature, as illustrated in FIG. 1.

We shall define two or more photovoltaic modules as non-homogeneous if:
they differ as regards their nominal characteristics (open-circuit voltage Vₒₚₑₙ_{_{—}}ₙ, short-circuit current I_{cc}_{_{—}}ₙ, maximum nominal power P_{P}_{_{—}}ₙ);
they differ as regards their nominal optimal operating point (maximum-power-point voltage, V_{MPP}_{_{—}}ₙ and maximum-power-point current I_{MPP}_{_{—}}ₙ);
they differ as regards their installation (orientation and inclination); and
they differ as regards their optimal operating point on account of non-uniform environmental conditions (solar irradiation and temperature), or else of non-coincidence with the nominal parameters.

The connection, in series and/or in parallel, of two or more non-homogeneous photovoltaic modules affects the power that can be delivered. In said conditions of non-homogeneity, the power-voltage characteristic presents a sequence of peaks, as illustrated in FIG. 2.

Whatever the operating point identified by the MPPT control, corresponding to a relative maximum or to the absolute maximum, the power that can delivered to the load will be lower than the maximum power obtainable with the sum of the maximum powers that can be delivered by each single module operating in its own absolute maximum, as appears evident from the comparison of FIG. 2 with FIG. 3.

Consequently, the implementation of the MPPT function using a DC/DC converter for each panel constituting a photovoltaic field and the consequent connection in series and/or in parallel of the photovoltaic modules, each operating in its own, absolute maximum of power that can be instantaneously delivered, enables maximization of the total power delivered by the photovoltaic field.

Typically, MPPT algorithms defined as “hill-climbing” or “perturbation” algorithms are used, in so far as they are the simplest ones to implement and the most reliable. “Hill-climbing” methods are based upon iterative algorithms: by perturbing the operating point of the system, the target of finding the direction in which there is an increase in the power delivered pursued. The evident advantage is that an in-depth knowledge of the characteristic of the source is not required. The development of said technique is favoured by the ease, of implementation of control systems made using digital components. On the other hand, a more complex design of the analog circuitry guarantees an increase in the performance.

Examples of operation and control of supply units, the power source of which is characterized by the presence of an absolute maximum on the curve of the power as a function of the voltage at the connection: terminals of the converter to the source, are described in the documents Nos. U.S. Pat. No. 4,794,272; U.S. Pat. No. 5,923,158; U.S. Pat. No. 6,009,000; U.S. Pat. No. B1 6,433,522; U.S. Pat. No. B2 6,844,739; U.S. Pat. No. B2 6,919,714; U.S. Pat. No. 5,869,956; U.S. Pat. No. 5,869,956; U.S. Pat. No. B2 6,611,441; U.S. Pat. No. 6,911,809; US-A-2004/0207366; and WO-A2 2005/112551.

Typically, the MPPT control algorithms are implemented with approaches of a digital type, a solution that presents numerous disadvantages.

A first disadvantage lies in the fact that, in addition to a microcontroller, there are also required: analog-to-digital conversion modules; memory modules; digital-to-analog conversion modules; and further supporting hardware. In addition to the higher direct cost, the indirect costs due to the greater encumbrance and the higher consumption are also to be considered.

Another evident disadvantage is the low speed at which the system responds for adapting the operating point, which is not compatible with an adequate level of performance required. Furthermore said solution is more sensitive to noise and to errors of measurement and quantization of the voltage, current, and power sensors.

M. Calais and H. Hinz, in “A Ripple-base maximum power point tracking algorithm for a single phase, grid-connected photovoltaic system.”, Solar Power vol. 63, No. 5, pp. 277-282, 1998, describe a method for tracking the maximum power point of a photovoltaic field, implemented with digital devices, which uses as perturbation the intrinsic oscillations due to the harmonics introduced by the network in a grid-connected photovoltaic system. Through the analysis of the waveforms of the voltage and of the power it is possible to identify in which area of the characteristic P-V the system is operating. The characteristic P-V can be divided into three areas, as illustrated in FIG. 4.

Said division can be, interpreted from an examination of the graphs in FIG. 5, which represent the oscillating voltage at the source terminals and the corresponding power. In the area A, the voltage is lower than the maximum-power-point, (MPP) voltage, whilst in the area C the voltage is higher than the MPP voltage. The harmonic component of the power and the harmonic component of the voltage are in phase in the area A and in phase opposition in the area C.

The above behaviour is re-proposable whenever the voltage vₚ(t) at the terminals of the photovoltaic source has a waveform that contains a sinusoidal component of frequency fₚ(t):

vₚ(t)=vₚ_{_{—}}ₙₚ(t)+Vₚ_{_{—}}ₚ(t)·cos(2πfₚ(t)·t+φₚ(t))

Said sinusoidal component can be generated by controlling a DC/DC switching converter, or else said sinusoidal component can be triggered by any intrinsic oscillation of the system not attenuated by the compensating network of the DC/DC switching converter.

The present invention basically regards an MPPT control method and the corresponding circuit architecture that enables the production of low-cost DC/DC switching converters of reduced dimensions, by means of which supply systems can be created, based upon sources of any kind, said sources being constituted by one or more power modules, each characterized by a maximum power point that is such as to guarantee delivery of the maximum instantaneous power by each power module, in this way maximizing the total power delivered by said systems.

In particular, the technique forming the subject of the present invention identifies the optimal maximum-power operating point using the relation lying between:

the harmonic component of the voltage vₚ(t) at the terminals of the photovoltaic source at a given frequency fₚ, the waveform of which can be expressed as:

vₚ(t)=vₚ_{_{—}}ₙₚ(t)+Vₚ_{_{—}}ₚ(t)·cos(2πfₚ(t)·t+φₚ(t))

and

the harmonic component of the power at the same frequency fₚ.

As will be seen more clearly from what follows, the control technique forming the subject of the present invention presents the following characterizing aspects and advantages:
it does, not require any setting of the parameters of the controller conditioned by identification of the dynamic parameters of the source-converter system to be controlled, and hence the control less sensitive in regard to the dynamic characteristics both of the source and of the DC/DC converter;
the logic on which the controller is based is completely of an analog type in so far as identification of the optimal operating point of the source is not effected either following upon numerical processing operations or through discrete events determined by operations of a conditional type carried out by means of digital circuits, but rather through identification of the condition of zeroing of an appropriate continuously valued time-continuous electrical signal;
it guarantees an extensive range of operation and stability and does not require adaptation of the parameters of the controller as the characteristics of the system and its conditions of operation change; in particular, it is not necessary to seek in real time, or through off-line procedures, the values, of the parameters of the controller that enable extraction of the maximum power from the source as said source changes, i.e., as the climatic conditions, or conditions of another kind, which determine the characteristics thereof, change;
the control consequently performs a function, herein defined and claimed with the term “Permanent Maximum Power Extraction” (PMPE), which consists in determining a permanent extraction of the maximum power from the source, whatever the value thereof, as the climatic conditions, or conditions of other kinds, which determine the instantaneous characteristic thereof, vary; said technique represents an improvement with respect to maximum power point tracking, as envisaged by existing MPPT techniques, of which it constitutes optimal embodiment.

### PURPOSES AND SUMMARY OF THE INVENTION

The main purpose of the present invention is to overcome the aforesaid problems by, providing a method and an apparatus for controlling a supply system that enables the maximum power that can be delivered by sources of any kind to be obtained, said sources being, constituted by one or more power modules, each characterized by a maximum power point and/or characterized by the presence of a local maximum on the curve of the power as a function of the voltage at the connection terminals, the component being set between the power source and the load, preferably a DC/DC switching converter.

More in general, the method according to the invention can be applied to converters for any power source that is characterized by the existence of particular specific conditions of operations deemed preferential, in relation to power produced, power efficiency, level of stress of the components, service life, or any other assessing factor that can be defined for the specific source, said conditions being variable as a result of climatic or physical factors, or factors of another nature, whether controllable or not, whether predictable or not, and identifiable through a particular point of local maximum or local minimum of one of the electrical output characteristics of the source, said characteristics being of the power-voltage, power-current, voltage-current, current-voltage, efficiency-voltage, efficiency-current type, or the like.

In said method, in the case, of the source characterized by the presence of a point of maximum in the curve of the power delivered as a function of the voltage at the terminals, the operating point corresponding to the maximum power is identified by the value of the d.c. component¹ V_{ref}_{_{—}}₀(t) of the reference V_{ref}(t) of the voltage at the terminals of the power source, obtained by solving the following equation:

Γ₀(t)=0 (1)

where Γ₀(t) is the d.c. component of the quantity Γ(t), which is the product between the power and the a.c. voltage component

Γ(t)=p(t)·vₐ(t)

or else the product of any signal proportional to the power end any signal proportional to the a.c. component of the voltage at the connection terminals of the converter to the source, or else the product of any signal proportional to the a.c. component of the power and any signal proportional to the voltage at the connection terminals of the converter to the source, or else the product of any signal proportional to the a.c. component of the power and any signal proportional to the a.c. component of voltage at the connection terminals of the converter to the source. ¹We define as “d.c. component” of a signal x(t) defined positive the following quantity:

$${x}_{0} ( t ) = \frac{1}{t} {\int }_{0}^{t} x ( τ ) \cdot d τ .$$

We define as “a.c. component” of a signal x(t) defined positive the following quantity:

xₐ(t)=x(t)−x₀(t)

The waveform of the quantity Γ₀(t), which justifies Equation (1) is illustrated in FIG. 6.

The purpose of the present invention is a control method, and the corresponding circuit architecture, for a supply system that enables extraction of the maximum power that can be delivered by sources of any kind constituted by one or more power modules each characterized by a maximum power, point and/or characterized by the presence of a local maximum on the curve of the power as a function of the voltage at the connection terminals, which is able to solve Equation (1) and is implemented at low cost with a minimum number of discrete analog devices and integrated analog devices of a widely used type.

With reference to the applications for renewable power sources, in particular photovoltaic sources, the present invention guarantees modularization of the function of extraction of the maximum power of the photovoltaic field, maximizing both the power efficiency (enabling connections in series and/or in parallel of non-homogeneous photovoltaic; panels of low nominal power (50-200 Wₚ), each of which operating in its own MPP) and the economic efficiency. Furthermore, said solution is proposable for systems of low nominal power (200-1000 Wₚ), generated by a single photovoltaic module or a limited number of photovoltaic modules, comprising supply units obtained with DC/DC switching converters. Furthermore, said solution is proposable as input stage of an inverter of average nominal power (1-20 kWₚ), which is able to supply at its output terminals an a.c. voltage both, for stand-alone systems and for grid-connected systems.

### DETAILED DESCRIPTION OF THE PREFERRED EMBODIMENT OF THE, INVENTION

The following description represents an example of the application of the invention to a maximum-power-point tracker of a solar generator. As mentioned previously, this represents an example of source characterized by the presence of an absolute maximum on the curve of the power as a function of the voltage at its own terminals.

FIG. 7 illustrates a block diagram of the device according to the present invention. In FIG. 7:
the reference number 1 designates the photovoltaic field, defined as a single photovoltaic module or else a set of two or more photovoltaic modules connected in series and/or in parallel;
the reference numbers 2 and 3 designate the power sensor pₚₐₙ and voltage sensor vₚₐₙ, respectively;
the reference number 4 designates the generator of the perturbing signal V_{ref}_{_{—}}ₚ(t)=V_{ref}_{_{—}}ₚ·cos(2πfₚ·t);
said signal cannot be present in systems that use as perturbing signal any intrinsic oscillation of the system not attenuated by the control network;
the reference number 5 designates, an adder, which, adds to the voltage V_{ref}_{_{—}}₀ the perturbing signal V_{ref}_{_{—}}ₚ·cos(2πfₚ·t);
the reference number 6 designates the circuit that generates the PWM signal that determines turning-on/turning-off of the active component or components of the DC/DC switching converter 7;
the reference number 8 designates a generic load that will be able to accumulate, and/or convert, and/or absorb all the power delivered at output from the DC/DC switching converter 7; and
the reference number 9 designates the control block that performs the function of permanent latching onto the maximum power point.

Represented in FIG. 8 is the diagram of the DC/DC switching converter 7 used in the preferred embodiment of the invention; the topology is that of a boost circuit. In FIG. 8, the reference numbers 44 and 48 designate capacitors, 45 designates the inductor, 46 is the MOSFET, and 47 is the diode.

Represented in FIG. 9 is the block diagram of the controller 9 that performs the function of permanent latching onto the maximum power point. The signal Γ is the product, obtained by the multiplexer 11, between the signal detected by the power sensor 2 and the signal proportional to the a.c. voltage component. In the preferred embodiment of the invention, said signal is the perturbing signal v_{ref}_{_{—}}ₚ filtered out, through the bandpass filter (BPF) 10, of the possible d.c. component, and in any case of the low frequencies, at least one decade lower than the frequency fₚ of the perturbation, and of the components at high frequencies, at least one, decade higher than the frequency fₚ of the perturbation. The d.c. component, which can be introduced by offsets, and other components at frequencies higher than fₚ, which can be introduced by disturbance, must, necessarily be eliminated. The presence of the BPF 10 within the controller 9 is likewise necessary in systems in which the perturbing signal is triggered by any intrinsic oscillation of the system not attenuated by the compensating network of the DC/DC switching converter.

The signal Γ is amplified and deprived of the frequency components at a frequency equal to or higher than fₚ through a lowpass filter (LPF) 12 of an order n sufficiently high to guarantee an adequate attenuation of the harmonic component at the frequency fₚ and, harmonics thereof. The signal Γ₀, thus generated is sent to the error amplifier 13 and compared with zero. The output of the error amplifier through a compensator 14 defines the reference voltage v_{ref}_{_{—}}₀.

The preferred circuit embodiment of the controller 9 is illustrated in FIG. 10. In FIG. 10, the components 16, 20, 24 and 28 are operational amplifiers, the components 18, 19, 22, 26 and 27 are resistors and the components 15, 17, 21, 25 and 29 are capacitors. The spectrum of the signal Γ at input to the LPF 12 is illustrated in FIG. 11. The harmonic components at frequency fₚ and at frequencies that are, multiples of higher order are visible said components must be suppressed. In the preferred circuit embodiment, said task is entrusted to the LPF 12. The error amplifier 13 and the compensating network 14 are provided by means of an operational amplifier 28 connected in the Miller-integrator configuration. The input Γ₀ in static conditions is zero, as illustrated in FIG. 12.

Used in the preferred embodiment of the invention is a signal proportional to the a.c. voltage component at the terminals of the photovoltaic field. The proportionality between the filtered perturbing signal and the a.c. voltage component at the terminals of the photovoltaic field is guaranteed by the circuit that generates the PWM signal 6 and is illustrated in FIG. 13.

The preferred circuit embodiment of the circuit that generates the PWM signal 6 is illustrated in FIG. 14 and is obtained with a conventional voltage-mode controller for DC/DC switching converters. The compensator is obtained with a PID controller 38, the transfer function of which is characterized by two poles, two zeros and one pole in the origin, designed so as to guarantee stability of the system at every condition of operation, wide bandwidth (wider than the bandwidth of the DC/DC switching converter not fedback), and a high disturbance rejection. In FIG. 13, the component 34 is an operational amplifier, the components 30, 32, 33 and 36 are resistors, and the components 31, 35 and 37 are capacitors. The PWM signal is generated by the comparator 40, which compares the output signal V_{c} of the PID controller 38 and the sawtooth signal Vₛ produced by the generator 39. The period of the sawtooth signal Vₛ, produced by the generator 39, and of the pulse signal produced by the clock generator 41, are equal to the switching period Tₛ, given by the inverse of the switching frequency of the DC/DC switching converter. The SR latch 42 performs the function of preventing phenomena of multiple switching of the MOSFET 46 of the DC/DC switching converter, turning-on of which is controlled by the output signal of the block 6 within the switching period Tₛ, said output signal from the block 6 being a square wave with period Tₛ and stay time in the high state equal to D·Tₛ, where the real variable D, referred to as duty-cycle, is a real number comprised between 0 and 1. The OR logic gate 43 defines the minimum value of the turning-on or conduction time Tₒₙ of the MOSFET 46.

The compensator 38 introduces a phase offset ψ contained between the perturbing signal and the a.c. voltage component at the terminals of the photovoltaic field. The value of ψ determines performance in terms of promptness and efficiency of the permanent latching onto the maximum power point of the controller. We have in fact:

Γ₀(t)=G(t)·cos(ψ) 0°≦ψ≦180 °

where G(t) is the maximum value that the d.c. component of the function Γ(t) can assume as a function of the instantaneous conditions of power that can be supplied by the source. A value of 90°≦ψ≦180° renders the system unstable, since it reverses the sign of the error signal. A value of 60°≦ψ<90° renders the system less rapid since it attenuates the error signal. To overcome said problem it is possible to increase the value V_{ref}_{_{—}}ₚ, even if the system became less efficient. The optimal value is hence 0°≦ψ<60° with best performance for ψ>0°.

The stability and the performance of the control technique forming the subject of the present patent application have been verified experimentally by means of the development and construction, at the Laboratory of Electronic Power Circuits and Renewable Sources of the Department of Computer Engineering and Electrical Engineering of the University of Salerno, of a prototype of DC-DC converter of the boost type represented in FIG. 8, and of the corresponding control circuitry, designed to meet the following specifications:
input voltage: 8 to 22V;
output voltage: 24V;
input current: 0.5 to 10 A;
maximum power: 150 W; and
operating mode: continuous.

The passive circuit components adopted presented the following characteristic parameters:
L(45): 100 μH;
Cᵢₙ(44): 94 μF; and
Cₒᵤₜ(48): 99 μF.

The controller was designed, according the principle illustrated in the present document, so as to guarantee proper operation of the system in the voltage and current ranges indicated in the specifications. Illustrated in FIG. 15 is the behaviour of the system at turning-on of the converter. The signal Ch3 corresponds to the voltage at the terminals of the photovoltaic field, displayed with an offset of 8V; the signal Ch4 corresponds to the output current of the photovoltaic field, where the vertical scale indicated as being of 10.0 mV/div is to be understood as being 1 A/div; the signal Math2 corresponds to the instantaneous power delivered by the photovoltaic field, in which the vertical scale indicated as being of 100 mVV/div is to be understood as being 10 W/div. The traces of the signals highlight the fact that the controller is able to latch autonomously, at turning-on, onto the operating point of maximum power, and, once the turning-on transient has terminated, the controller permanently guarantees extraction of the maximum power from the photovoltaic field, minimizing the oscillations about the maximum power point and consequently maximizing the power efficiency of the system.

1-21. (canceled)

22. A method for controlling operation of a supply unit for supplying power coming from an electric-power source having an absolute maximum on the power curve that is a function of the voltage at the connection terminals of said source, characterized in that it comprises the steps of:
A. extracting d.c. electric power from said source;
B. converting, by means of a DC/DC converter, the voltage and the d.c. current at the terminals of the source into a d.c. voltage and current suitable for the load or apparatus that it is intended to supply;
C. maximizing the disturbance rejection on the electrical quantities to the ends of the source induced by exogenous changes to the DC/DC converter and removing all exogenous oscillations due to the adaptor or to the load or to the source;
D. generating a reference signal Vref_0(t) such that, for each value of t>0, the Equation Γ₀(t)=0 is verified, where Γ₀(t) is the continuous component of the quantity Γ(t), which is the product between the power and the alternative voltage component:
Γ(t)=p(t)·vₐ(t);
E. introducing a perturbation consisting in an oscillating signal Vref_p(t) controlled and programmed at a given frequency;
F. generating a control signal Vc(t) obtained comparing said reference signal Vref(t) given by the sum of the signals Vref_0(t) and Vref_p(t), with a signal proportional to the voltage at the terminals of the electric-power source;
G. as a function of said control signal, adjusting an appropriate control parameter of said converter.

23. The method according to claim 22, characterized in that the converter referred to in step B is a DC/DC switching converter.

24. The method according to claim 22, characterized in that said power source is constituted by at least one photovoltaic panel or module, said method comprising the step of identifying a point of delivery of the maximum power according to the conditions of temperature and solar irradiation on said panel.

25. The method according to claim 22, characterized in that the quantity Γ(t) is the product between a signal proportional to the power and a signal proportional to the alternative component of the voltage at the connection terminals of the converter to the power source and is defined by the following equation:
Γ(t)=αₚ·p(t)·αᵥ·vₐ(t).

26. The method according to claim 22, characterized in that the quantity Γ(t) is the product between a signal proportional to the alternative component of the power and a signal proportional to the voltage at the connection terminals of the converter to the power source and has the following equation:
Γ(t)=αₚ·pₐ(t)·αᵥ·v(t).

27. The method according to claim 22, characterized in that the quantity Γ(t) is the product between a signal proportional to the alternative component of the power and a signal proportional to the alternative component of the voltage at the connection terminals of the converter to the power source and is defined by the following equation:
Γ(t)=αₚ·pₐ(t)·αᵥ·vₐ(t).

28. The method according to claim 22, characterized in that said control parameter of the converter is the duty-cycle (D), defined as ratio between the time Tₒₙ of conduction of the active component and the switching period Tₛ.

29. A device for controlling operation of a supply unit for supplying power coming from an electric-power source having an absolute maximum on the power curve that is a function of the voltage at the connection terminals of said source, characterized in that said supply unit comprises:
means designed to extract d.c. electric power from said source;
a DC/DC converter for converting the d.c. voltage and current at the terminals of the source into a d.c. voltage and current suitable for the load or apparatus that it is intended to supply;
means for maximizing the disturbance rejection on the electrical quantities to the ends of the source induced by exogenous changes to the DC/DC converter and for removing all exogenous oscillations due to the adaptor or to the load or to the source;
means designed to generate a reference signal Vref_0(t) such that, for each value of t>0, the Equation T₀(t)=0 is verified, where Γ₀(t) is the continuous component of the quantity Γ(t), which is the product between the power and the alternative voltage component and is defined by the following equation:
Γ(t)=p(t)·vₐ(t);
means for introducing a perturbation consisting in an oscillating signal Vref_p(t) controlled and programmed at a given frequency
means for generating a control signal Vc(t) obtained by comparing said reference signal Vref(t) given by the sum of the signals Vref_0(t) and Vref_p(t) with a signal proportional to the voltage at the terminals of the electric-power source; and
means designed to adjust appropriately a control parameter of said converter as a function of said control signal.

30. The device according to claim 29, characterized in that said DC/DC converter is a switching converter.

31. The device according to claim 29, characterized in that said power source comprises at least one photovoltaic panel or module and in that it comprises means for identifying a point of delivery of the maximum power.

32. The device according to claim 29, characterized in that the quantity Γ(t) is the product between a signal proportional to the power and a signal proportional to the alternative component of the voltage at the connection terminals of the converter to the power source and is defined by the following equation:
Γ(t)=αₚ·p(t)·αᵥ·vₐ(t).

33. The device according to claim 29, characterized in that the quantity Γ(t) is the product between a signal proportional to the alternative component of the power and a signal proportional to the voltage at the connection terminals of the converter to the power source and is defined by the following equation:
Γ(t)=αₚ·pₐ(t)·αᵥ·v(t).

34. The device according to claim 29, characterized in that the quantity Γ(t) is the product between a signal proportional to the alternative component of the power and a signal proportional to the alternative component of the voltage at the connection terminals of the converter to the power source and is defined by the following equation:
Γ(t)=αₚ·pₐ(t)·αᵥ·vₐ(t).

35. The device according to claim 29, characterized in that said control parameter of the converter is the duty-cycle (D), defined as ratio between the time Tₒₙ of conduction of the active component, and the switching period Tₛ.

36. The device according to claim 29, characterized in that it comprises:
a photovoltaic field (1), comprising one or more photovoltaic modules connected in series and/or in parallel;
at least one power sensor pₚₐₙ (2) and at least one voltage sensor vₚₐₙ (3);
an adder (5), which adds to a reference voltage V_{ref}_{_{—}}₀ a perturbing signal V_{ref}_{_{—}}ₚ·cos(2πfₚ·t);
a circuit (6), which generates the PWM signal that determines turning-on/turning-off of the active component or components of the DC/DC switching converter (7);
a generic load (8), which will be able to accumulate, and/or convert, and/or absorb all the power supplied at output by the DC/DC switching converter (7); and
a control block (9), which performs the function of permanent locking to the maximum power point.

37. The device according to claim 36, characterized in that it comprises a generator (4) of the perturbing signal v_{ref}_{_{—}}ₚ(t)=V_{ref}_{_{—}}ₚ·cos(2πfₚ·t).

38. The device according to claim 36, characterized in that the DC/DC switching converter (7) has a topology substantially similar to a boost circuit, comprising two capacitors (44 and 48), an inductor (45), a MOSFET (46), and a diode (47).

39. The device according to claim 36, characterized in that the MPPT controller (9), which performs the function of permanent locking to the maximum power point comprises:
a multiplier (11), which generates a signal Γ by multiplying the signal detected by the power sensor (2) and the signal proportional to the voltage alternative component;
a bandpass filter (BPF) (10) for filtering the perturbing signal v_{ref}_{_{—}}ₚ from the undesired components;
a lowpass filter (LPF) (12), of order n that is sufficiently high to guarantee an adequate attenuation of the harmonic component at the frequency fₚ and harmonics thereof, designed to amplify the signal Γ and to deprive it of the components at frequencies equal to and higher than fₚ, generating a signal Γ₀;
an error amplifier (13), which receives the signal Γ₀ and compares it with zero;
a compensator 14, designed to define the reference voltage V_{ref}_{_{—}}₀ as a function of the output of the error amplifier (13);

40. The device according to claim 36, characterized in that the MPPT controller (9) comprises: operational amplifiers (16, 20, 24 and 28); resistors (18, 19, 22, 23, 26 and 27); and capacitors (15, 17, 21, 25 and 29).

41. The device according to claim 36, characterized in that the circuit that generates the PWM signal (6) comprises:
a conventional voltage-mode controller for DC/DC switching converters;
a compensator obtained with a PID controller (38);
an operational amplifier (34);
resistors (30, 32, 33 and 36);
capacitors (31, 35 and 37); and
a comparator (40) that generates the PWM signal, comparing the output signal V_{c} of the PID controller (38) and the sawtooth signal Vₛ produced by a generator (39); the period of the sawtooth signal Vₛ produced by the generator (39) and of the pulse signal produced by a clock generator (41) being equal to the switching period Tₛ, given by the inverse of the switching frequency of the DC/DC converter; and
an SR latch (42), designed to prevent phenomena of multiple switching of a MOSFET (46) of the DC/DC switching converter, turning-on of which is controlled by the output signal of the PWM (6) within the switching period Tₛ.
